(19) United States
(12) Patent Application Publication
(10) Pub. No.: US 2011/0238463 A1
(43) Pub. Date: Sep. 29, 2011

(54) ELECTRONIC VOTE PRODUCING AN AUTHENTICATABLE RESULT

(76) Inventor: Nicolas Marchal, Argenteuil (FR)

(21) Appl. No.: 13/057,742

(22) PCT Filed: Jul. 28, 2009
(86) PCT No.: PCT/FR2009/000940

§ 371 Date: Jun. 9, 2011

(30) Foreign Application Priority Data
Aug. 7, 2008 (FR) 08/55467

(51) Int. Cl. G07C 13/00; G07C 13/02

(52) U.S. Cl. 705/12

(57) ABSTRACT

Method of authenticating and counting through a secure electronic voting system and electronic voting system implementing such a method. The object of the present invention is to allow: all voters to authenticate, anonymously, their vote or votes through the listing of the votes counted for the electoral result; all third parties: to count the votes through the listing of the votes counted for the electoral result and to verify the voting rights through the electoral list. The invention proposes that a unique and confidential validation code be generated for each voter of an electoral list (FIG. 5 no. 226). At the completion of the electoral procedure, the voter, by virtue in particular of his validation code or codes, will be able to ascertain his voting number or numbers which will enable him to authenticate, inarticular through the Internet, his vote or votes cast through the electoral result. Voters and third parties will be able, through this result, to verify the reckoning of the votes constituting the electoral result.

### FIELD OF THE INVENTION

The present invention relates to the field of electronic voting systems and has the object of:
providing voters a process of authenticating their vote(s) after the announcement of election results,
providing voters and third parties a method of verification of the computation of votes in the listing of election results announced after the election procedure.
being able to provide a voting procedure that enables an anonymity over the votes cast,
ensuring the security of the system as attacks relating to the authenticity of the election results are likely to be proven by the innovative devices. The election result can thus become irrefutable.

### PRIOR ART

Today, every election involves a voting procedure implementing the verification of the right to vote of the voter by those in charge of monitoring, the selection by the voter of a choice, the deposit of this choice in a ballot box and a signing before those in charge of monitoring it. To this voting procedure is added a counting procedure that includes the verification of the number of votes to the number of voters, the counting of the vote, the establishment of the list of results and the authentication of these lists by human scrutinizers.

Due to human and political psychological implications associated with an election, the procedures for voting and counting are complex and lengthy. They are even more complex and lengthy as they are performed by volunteer scrutinizers, distrustful and untrained.

Currently, to simplify the voting and counting procedures, automated electronic voting methods and systems have been implemented. These electronic voting systems enable paperless voting by using dedicated machines or conventional computer terminals. In such systems, voting data are transmitted to servers through a communication network such as, in particular, the Internet or the telephone network.

According to the types of election, such systems enable voting in polling stations provided with assigned staff to monitor the electoral process, or from a place outside the polling station such as workplace or home. The use of such voting systems requires assuring to the voters the authenticity of the vote cast as well as the complete confidentiality of the vote of each voter. The security and anonymity of the vote ballots are requirements of electronic voting systems.

The voters, via an electronic voting system, are obliged to trust the service providers who manage these voting systems in terms of both respect for their anonymity or the authenticity of the vote(s) they cast. However, due to the climate of suspicion surrounding any election and the fact that the votes are cast via an automated voting system, the anonymity of voters and the authentication of votes are naturally put into question by the voters.

To meet this requirement of anonymity and remove this doubt, many studies have been conducted. Most of the studies focus on different cryptographic techniques. But any cryptographic technique is by nature reversible, which reinforces the mistrust of voters toward current voting systems. Indeed, a third party with more or less difficulty can decrypt the encrypted information and identify the voter's choice and break the chain of anonymity and thus the confidentiality of the vote. Especially because of the constitution of an electoral list for the voters and a list of votes cast by voters, it is relatively easy, from the decryption, to make a computer connection between these two lists. This connection allows said third parties to know the electoral choice of all the voters thus breaking the secrecy of the vote.

Today, there is no way to ascertain that a computer election result obtained via an electronic voting system is authentic, as it results from the computation of votes actually cast by the voters duly qualified to vote. For the security of an electronic voting system, a chain of authority, that “certified” this electronic voting system, must be trusted.

There exists thus today a need to ensure that the votes cast via an electronic system are:
authentic, that is to say that the content of the physical ballot box (tangible vote ballots if available for the electoral process) and the computer ballot box of the server corresponds to the vote ballots validated by the voters and that no fraudulent manipulation affected this content. Manipulation can consist of attempts to add or delete vote ballots or voters on the electoral list, or to change/replace all or part of the vote ballots, and
anonymous, that is to say it must be possible, according to the type of vote, to ensure total anonymity on the votes cast. Impossibility of knowing who voted for what, or of knowing that this vote is by whom.

Description of the electronic voting device object of the invention:

An object of the invention is to overcome the disadvantages of the techniques described above. For this, the invention proposes, first, an anonymous authentication procedure in the final result of the vote(s) cast and verification of the computation of votes cast. Second, ensuring the security of the electronic voting system in order to make the election result irrefutable using available authentication devices.

In order do this, the voting device proposes to generate for each voter on the electoral list, a confidential vote code that allows only one right to vote for the vote(s) of which his vote code contains data on voting categories (FIG. 1 n° 18) assigned to this code.

Multiple types of vote code (FIG. 9 No. 103) are available according to the parameterization of the electoral process, code:
Identity (only the identity of the voter and the vote (s) are presented)
Categorical (assignment of categories to the voter: FIG. 15 voting No. 3,
Nominative (enable nominative signing of the vote: FIG. 15 row 2,
Anonymous (total anonymity: FIG. 15 row 1 and FIG. 11 row 3
Identity/Category : FIG. 15 row No. 9 and FIG. 11 row No. 5,
Nominative/Categorical : FIG. 15 row No. 5 and FIG. 11 row No. 6,
Anonymous/ Categorical: FIG. 15 row No. 7 and FIG. 11 row No. 4,

Only the identity vote code enables, at the time of display of the election result, knowing the identity of the voter for the vote cast with this vote code. According to the voting procedure, legislation may in fact allow the disclosure of electoral choice and of the corresponding voter.

For all the other types of vote code, it is impossible, with only the indication of the vote code, to know the electoral choice(s) cast by a voter tenderer of a vote code. Indeed, the vote(s), that has/have been validated and confirmed by a voter, has/have no computer correspondence with the vote code. Anonymity is thus assured. However, in case:
of non-voting, thus a voter who has not inputted or entered his vote code, then his vote(s) will correspond to abstention(s),
of presentation or entering of the vote code, but of non-confirmation of all the proposed votes,

these two hypotheses constitute exceptions. For these abstentionist votes there will be a linking with the vote codes of the voters. The base 57 (FIG. 1) contains the abstentionist votes attached to the vote code of the abstentionist vote for the two cases above. These voters do not have a validation code for these abstention votes. They will thus be required to enter (FIG. 6 No. 263a) their vote code to know the vote number(s) that the device will have automatically generated for the abstention vote(s).

If the input or entry of the vote code on the electronic voting device (FIG. 5 No. 221) is recognized, the voter casts his electoral choice (FIG. 5 No. 225) and the electronic voting system provisionally generates (FIG. 5 No. 226) a unique vote number and a validation code. Subsequently, by a validation, the validation code and the vote number will be provisionally assigned (FIG. 5 No. 242 or 252) to the voter's electoral choice. However, if and only if the voter confirms his vote(s) (FIG. 5 No. 245 or 257), the provisional assignment(s) will be definitely assigned to this (these) electoral choice(s).

The validation code is the essential point of the invention. The validation codes are unique and recorded on a computer base (FIG. 1 No. 56) different from that of the vote codes (FIG. 1 No. 18). The validation code is thus personal, unique and confidential. His validation code(s) can be shown to the voter on:
the voting terminal of the electronic voting device (FIG. 5 No. 241 or 251),
the possible vote ballot(s) (FIG. 5 No. 253), that, advantageously, have been allowed for the electoral process, and
the receipt for the vote(s) cast (FIG. 5 No. 244 or 256). This vote receipt is retained by the voter.

Only the vote receipt provided outside the polling station (FIG. 12) indicates the vote(s) cast.

The validation of a selected electoral choice (FIG. 5 No. 241 or 251) results in the generation of a virtual vote ballot including in particular the vote choice and the vote numbers and the validation code, which is different from the vote code. One and only electoral choice is associated with each validation code. Each vote ballot thus corresponds to a unique validation code. This/these vote ballot is/are then transmitted in a virtual ballot box of the electronic voting system in order to be counted if the voter confirmed (FIG. 5 No. 257 or 245) his vote receipt.

In order to reinforce the confidentiality of the voters' choice(s), with each confirmed or abstentionist vote ballot is associated a unique vote number the correspondence of which cannot be known except by the voter according to a secured procedure. After the election procedure, it is from the validation code(s) (for the confirmed vote(s)) or from the vote code (for the vote(s) that has/have not been confirmed), that the elector registered on the electoral lists will be able to view (FIG. 3 No. 99) the vote number(s) associated with his vote ballot(s). It must be in no way be possible to be able to fix a vote number on any substrate. Indeed, only the voter needs to know the vote number(s) assigned to his vote(s) in order to avoid vote-buying. From his vote number(s), the voter can authenticate and verify the computation of his vote(s) from the public electoral results (FIG. 11) containing all the electoral votes, which are assigned a respective vote number. If his/her vote(s) is/are correctly accounted for, no fraud can affect this/these vote(s). This electoral result is in table format where each row corresponds to a vote number and columns indicate a vote choice associated respectively with a single vote number.

Thus with the invention, the authentication and the counting of the votes are accessible to the voters, and no longer only under the responsibility of the manager(s) of the electronic vote device. In the case of anomaly in the results, the vote receipt provided to the voter and/or the vote ballot possibly inserted into the physical ballot box by the voter can authenticate. In addition the invention, the anonymization of voters is ensured because the vote ballots are associated with the validation code and not with the vote code.

The invention thus enables supplementation of the existing electronic voting systems in order to reinforce the confidentiality of the voters and the authenticity of the votes. An object of the invention is thus an electronic voting method, characterized in that it comprises the following steps:
A vote code file, individualized and confidential to each voter identified from a predefined voter group, is generated, this vote code file being in the form of a first sequence of characters and being communicated in a form readable to each voter,
A man-machine interface is connected to a vote server via a communication network,
A voter inputs or enters and possibly confirms his vote code file on the man-machine interface, and
The voter can express at least one vote choice, in particular by selection from a predefined choice memory, and
At the time of an authorization, a provisional generation of vote number and validation code files is created (FIG. 5 No. 226).
At the time of a first validation (FIG. 5 No. 241 or 251), a provisional vote ballot file is created, the provisional vote ballot file including: a piece of information about the choice of vote cast by the voter and an association with the validation code file and the vote number file. The validation code file is in the form of a second sequence of characters, distinct from the sequence of characters generated for the vote code. In a variation, it is possible that the voter totally or partially composes, on the voting terminal, the characters of his validation code
The assigned vote number is not necessarily in a continuous order, but is unique by vote ballot and abstention ballot file. The data of the vote number associated with the vote number file and thus with the vote ballot file being publicly accessible.
Advantageously, in case of the printing of the vote, a second validation must be effected regarding the printed vote ballot (FIG. 5 No. 254)
At the time of a confirmation (FIG. 5 No. 245 or 257), a definitive computer correspondence is created, between the vote ballot file and the validation code and vote number files.
Advantageously, the data of the vote ballot file can be printed on a physical substrate of the vote ballot, understandable by the voter.
Advantageously, a vote receipt including in particular the generated validation code file(s), is printed.
Advantageously, the tangible vote ballot is placed in the tangible ballot box by the voter. Advantageously, the tangible ballot box is adapted to read the data contained on the substrate during the insertion, and a comparison can be effected between the vote ballots coming from the ballot box and the computer votes (FIG. 5 No. 263).
Advantageously, the comparison comprises, as a verification, the following steps:
for each validation code file, the choice expressed in the vote ballot file recorded in the storage means of the server is compared to the vote ballot stored in the physical ballot box,
an anomaly is detected when the two vote ballots are not identical.
For the counting of the vote, failing the effected comparison (FIG. 5 No. 263), the vote ballot files for producing a vote result are used (FIG. 5 No. 270).
When the vote is closed, an abstention ballot file, for the voters not having inputted or entered their vote code or confirmed their vote receipt, is created. These extension ballot files include abstention data, and a vote number is associated with these extension ballot files.
Counting is performed from the validation codes for the confirmed vote ballot files and from the vote codes for the abstentions, (voter not having: inputted or entered their vote code or confirmed their vote receipt). These results being recorded in the storage means of the server.
A list of votes, including the vote numbers associated with their vote or abstention ballot files, is provided, this list being publicly accessible.
Advantageously, the voter can know his vote number(s) associated respectively with his validated or non-validated votes (action to be repeated as many times as there is a vote to know all the vote numbers) by the following procedure:
the voter enters or even confirms his validation code file on a terminal provided with a secure connection to the vote server to obtain the vote number respectively associated with the vote ballot file.
the voter inputs or enters, or even confirms, his vote code file on a terminal provided with a means of secured connection to the vote server to obtain his vote numbers. Here it is considered the case of vote(s) declared abstentionist, thus a validation code cannot exist.
Advantageously, the voter consults the vote result list with the number of his vote to ensure the authentication of the recorded vote with his real vote (action to be repeated for all the vote numbers).

### BRIEF DESCRIPTION OF DRAWINGS

The invention will be better understood upon reading the description that follows and upon examining the figures that accompany it. These are presented by way of illustration and not limitation of the invention.

FIG. 1 shows a schematic representation of a voting system provided with sophisticated means of the invention, via a polling station.

FIG. 2 shows a schematic representation of a voting system provided with sophisticated means of the invention, via a terminal located outside a polling station.

FIG. 3 shows a schematic representation of a secured connection between a terminal and a server of the voting system for viewing the vote number file(s)

FIG. 4 shows an illustration of means implementing mode of generation vote file-code.

FIG. 5 shows an illustration of means implementing the method of the invention.

FIG. 6 shows an illustration of the flow chart of a method of voting in polling station and outside a polling station.

FIGS. 7-15 show examples of illustrations of the required elements to a vote.

### DETAILED DESCRIPTION OF IMPLEMENTATION MODES OF THE INVENTION

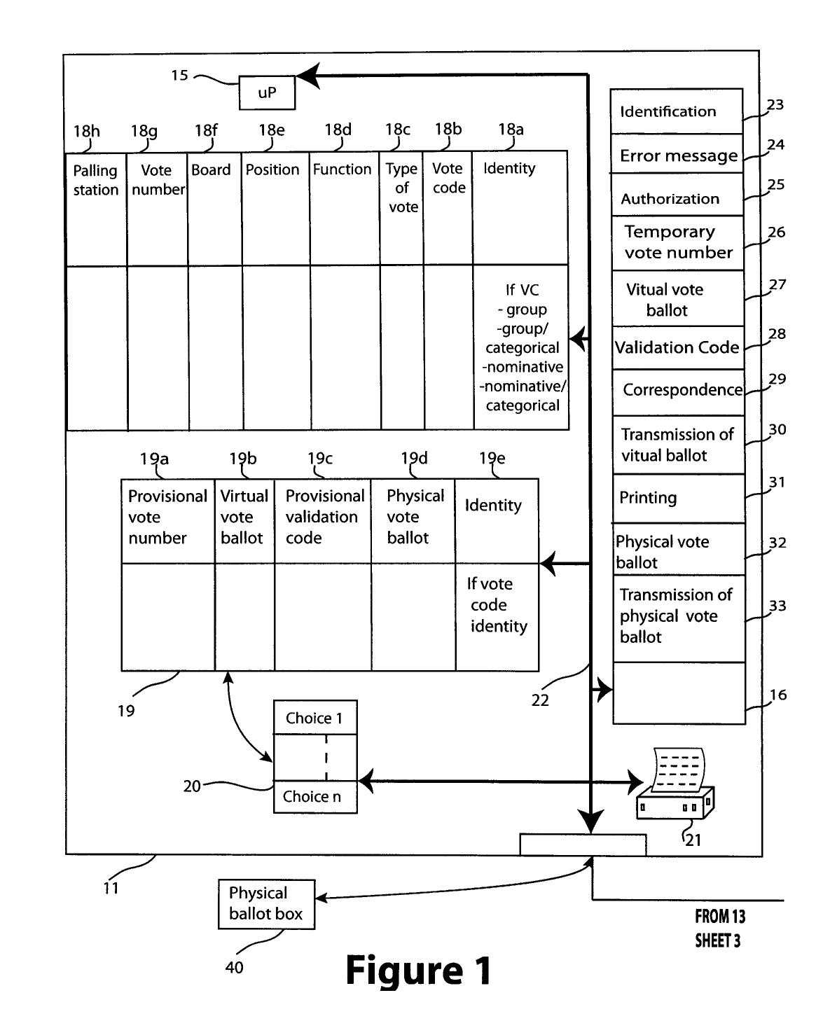

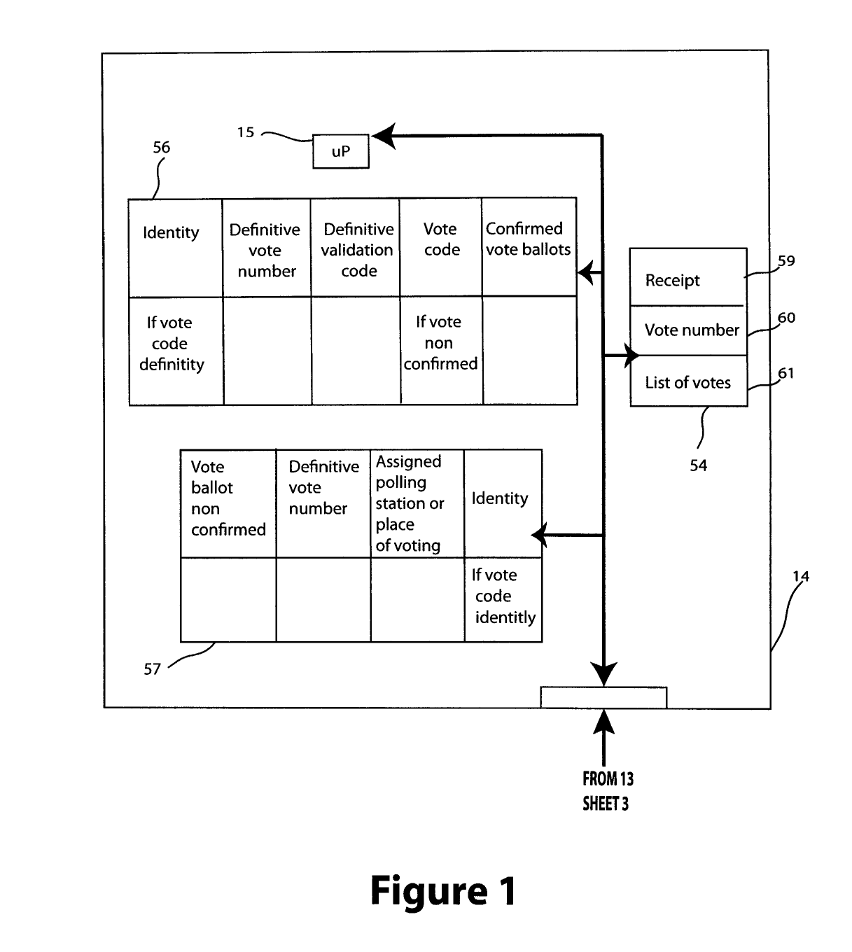

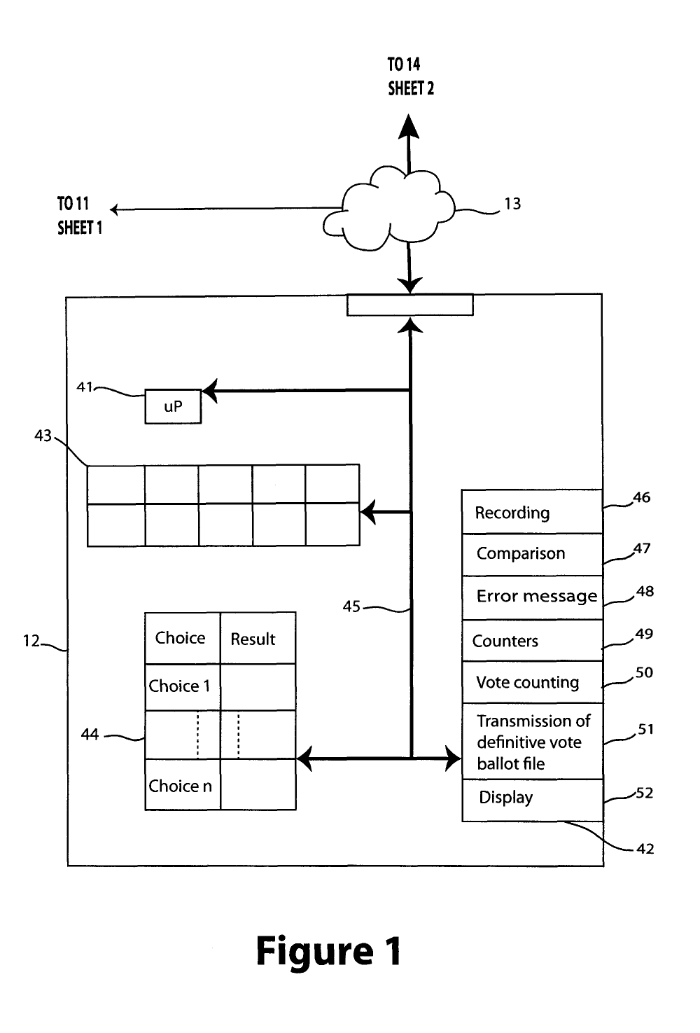

FIG. 1

Shows an electronic voting system via a polling station. The polling station is provided with at least one voting terminal 11 connected to at least one voting server 12 via a communication network 13. This voting server 12 is connected to all the terminals 11 of the aforementioned polling station. This communication network 13 can be, among other things, an Internet network, a mobile or fixed telephone network, or a wifi network. The voting server 12 is connected to a server 14 for centralization of all of the votes via the network 13.

In the description, actions are dispatched to apparatuses or to programs, this means that these actions are executed by a microprocessor of this apparatus or of the apparatus including the program, the aforementioned microprocessor being then controlled by instruction codes stored in a memory of the apparatus. These instruction codes enable implementation of the means of the apparatus and thus to achieve the business action.

The voting terminal 11 is a voting machine that principally includes a microprocessor 15, a program memory 16, a data base 18 of voters, a data base 19 of votes cast, a data base 20 of vote choice and a printer 21. The elements 15 to 21 are connected via a bus 22. The voting terminal 11 can also include a touch screen and/or keyboard.

The program memory 16 is divided into multiple areas, each area corresponding to a function or a mode of operation of the program of the voting terminal

An area 23 includes instruction codes to compare a vote code inputted or entered by a voter via the touch screen and/or keyboard, to the vote codes of the vote code files recorded in the data base 18. In the description, a file means a recording in memory of a piece of information. Thus the vote code file means that a piece of information, that is to say a vote code which is a sequence of characters, is stored in a file of the memory. The vote code can also be a random alphanumeric sequence or sequence of characters including biometric data.

An area 24 includes instruction codes to send an error message on the terminal screen 11, when the comparison returns zero, that is to say when the vote code inputted or entered does not correspond to any of those of the data base 18. The error message can be “vote code incorrect”.

An area 25 includes instruction codes to examine the column 18g of the database 18 in order to extract from there the vote number n associated with the aforementioned vote code file, n being the vote number authorized. This extraction is made when the comparison of the vote code file returns one, that is to say when vote code entered corresponds to one of those of the database 18. The instruction codes of the area 25 compare this number n to a number n from a vote counter (not shown). If the vote number n authorized is equal to the number from the vote counter, then the instruction codes of the area 25 send an error message on the terminal screen 11. This error message can be “vote code already used”. If the vote number from the vote counter is less than n, then the instruction codes of the area 25 send a vote authorization message to the vote terminal 11. This authorization message includes a list of choices extracted from the data base 20. This authorization message corresponds to a vote authorization for the voter.

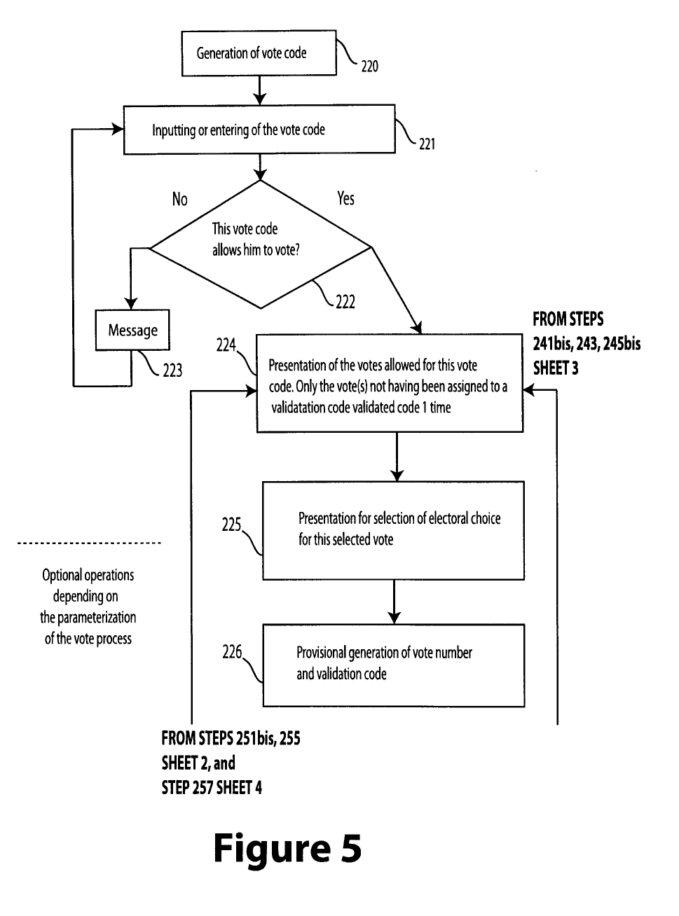

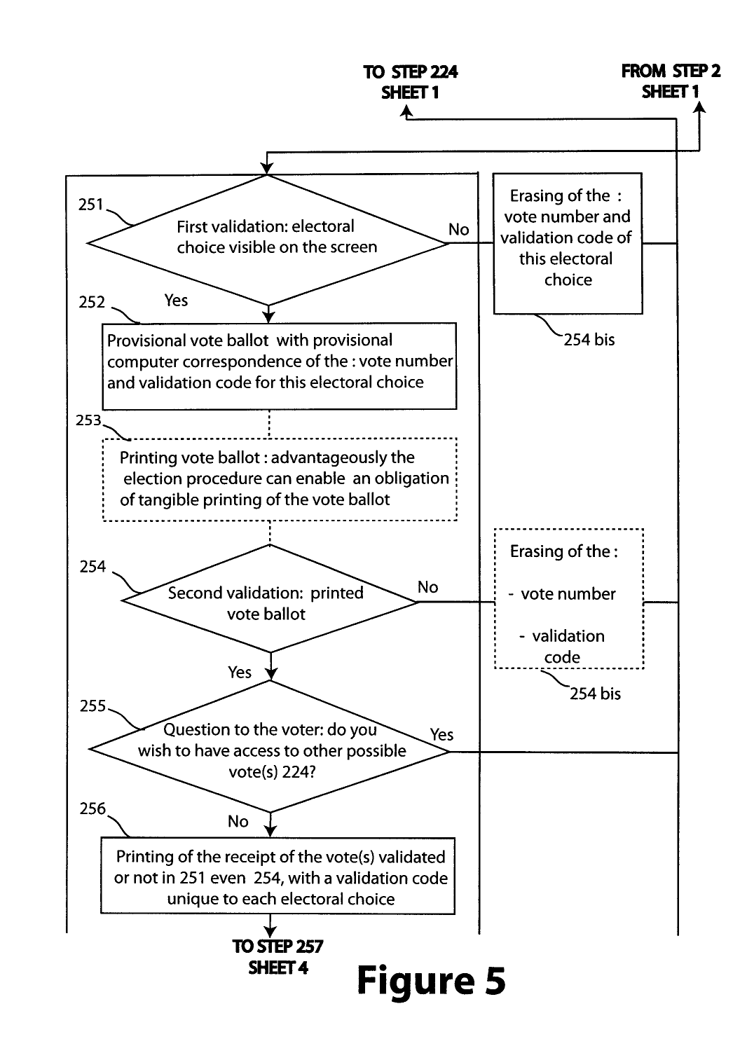

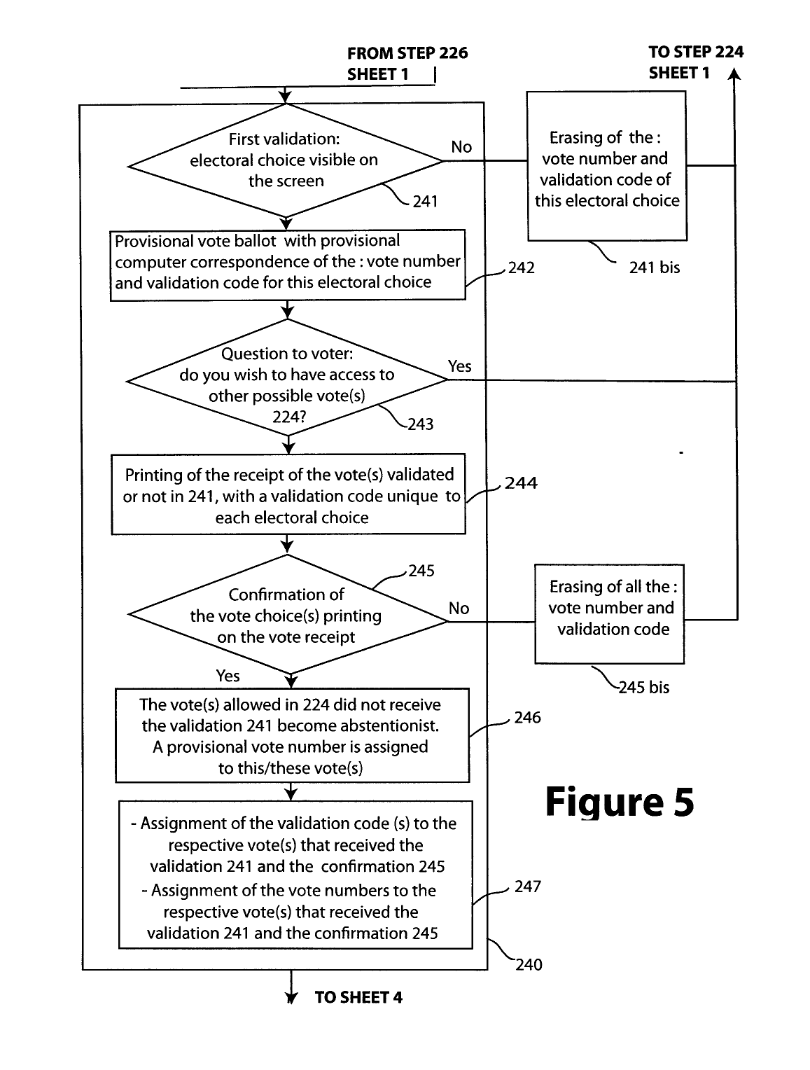

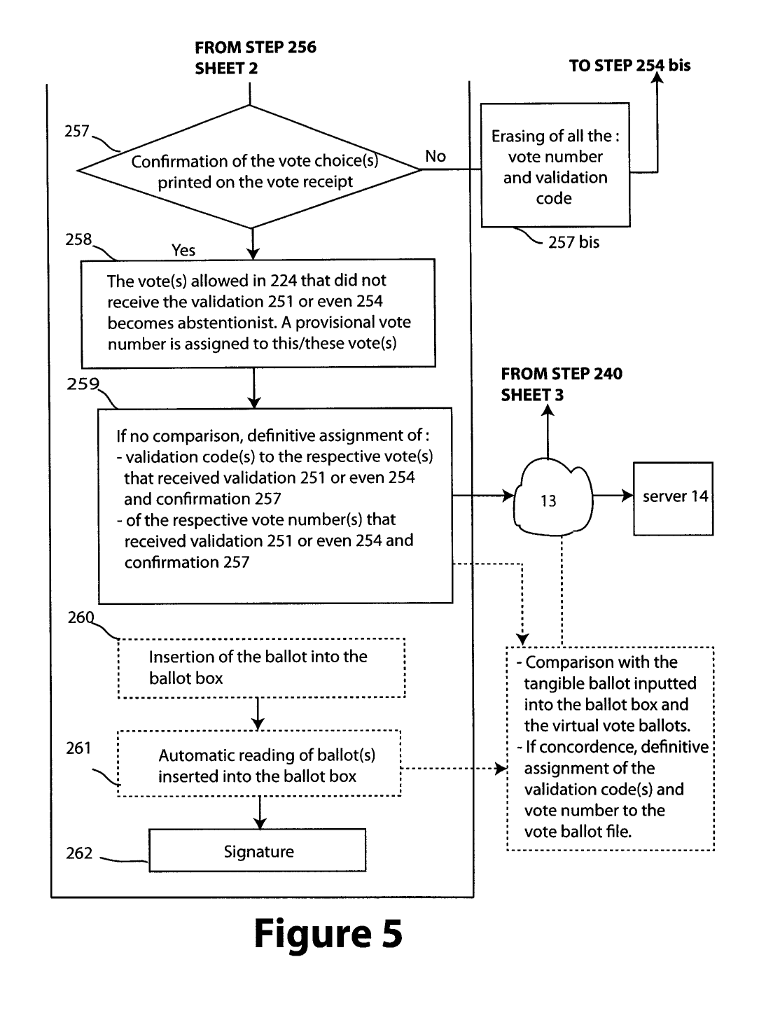

An area 26 includes instruction codes to assign a provisional vote number to the voter (FIG. 5 No. 226). This provisional vote number is preferably assigned chronologically during the vote authorization.

An area 27 includes instruction codes to create a vote ballot file associated with the provisional vote number and provisional validation code. In the remainder of the description, a vote ballot file corresponds to a recording in a virtual ballot box for a virtual vote ballot including a piece of information about the vote choice selected and confirmed by the voter. An abstention ballot file corresponds to recording in a virtual ballot box of virtual vote ballot including a piece of information about a voluntary or involuntary abstention. This piece of information is accompanied by the cause of the aforementioned abstention. This cause can be:
the vote code was not obtained and thus inputted or entered by the voter,
the voter did not input or enter, on the vote terminal, the picked up vote code,
the voter did not insert the possible physical ballot into the ballot box or has not signed when it was necessary to validate the vote,
the voter did not validate and/or confirm the selection of the computer vote.

The instruction codes of the area 27 create an abstention ballot-file associated with a definitive vote number when the vote is closed and the selected choice was not confirmed.

An area 28 includes instruction codes to receive a code validation file associated with the vote ballot file when this vote was validated by the voter. This validation code file includes a validation code existing in the form of a sequence of random characters. The validation code from the code validation file can be: displayed on the screen of the vote terminal 11, printed on the vote ballot and printed on the cast vote receipt. Each validation code file is unique for each vote ballot file. The instruction codes of the area 28 increment the vote counter at each generation of a validation code. The validation code of the validation code file is different from the vote code of the vote code file.

An area 29 includes instruction codes to record the validation code file and vote number associated with the vote ballot file in the data base 19.

An area 30 includes instruction codes for transmitting to the vote server 12 the definitive ballot file associated with the validation code file and with their vote number.

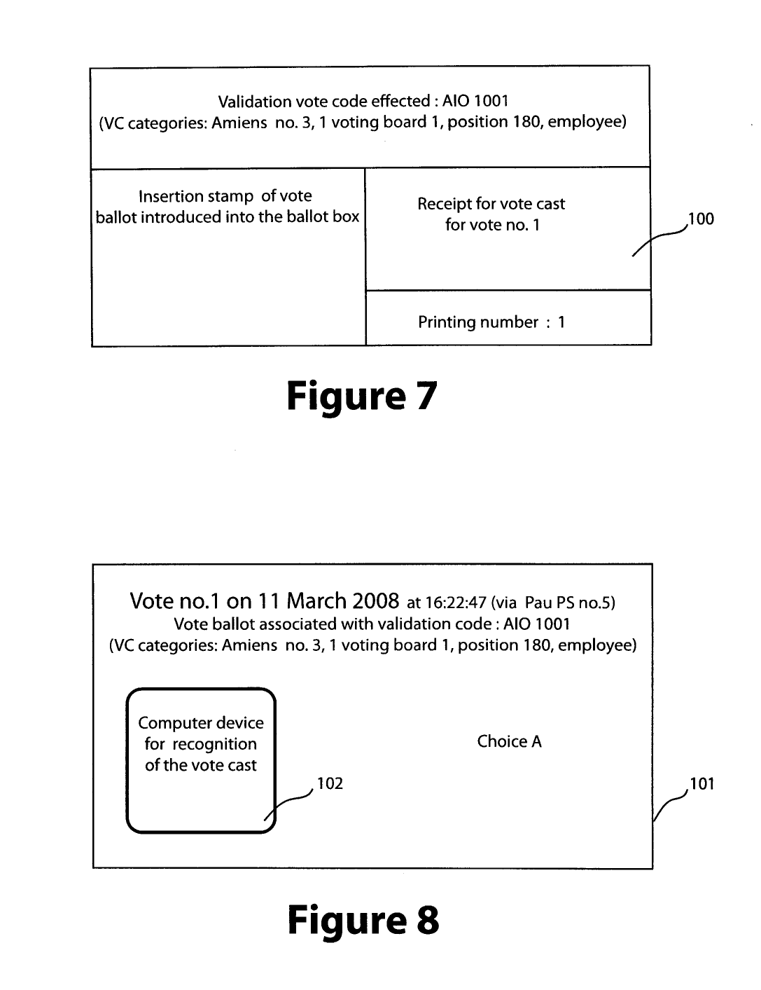

An area 31 includes instruction codes to start the printing of a vote receipt (FIG. 7) on a printer 70 connected to the terminal 11. The vote receipt includes, in particular, the validation code file. It can also include: the place of the vote, the assigned polling station and possibly the choice of the vote. It is however preferable that the vote receipt not include the choice of vote in order to avoid for example vote buying or voting under duress. An example of a receipt delivered by the polling station is shown in FIG. 7. The area 31 includes instruction codes to possibly print in or on a physical vote ballot (FIG. 8) data from the ballot file. The physical ballot can be made in particular in the form of a barcode or IC card (FIG. 8 no. 102). The barcode or the IC of the IC card includes data about the vote cast such as, in particular, the choice of the voter, the validation code and the assigned polling station. No nominative indication about the voter is shown on the vote ballot. FIG. 8 shows an example of a physical vote ballot in the form of an IC card 102. On this vote ballot are inscribed elements enabling the voter to verify the vote cast before the insertion into the physical ballot box (FIG. 1 number 40).

An area 32 includes instruction codes to analyze data received from the physical ballot box 40. The physical ballot box can be an IC card reader or an optical barcode reader. Generally, the physical ballot box is a reader to support the physical ballot. In the example of FIG. 8, the ballot box is an IC card reader. The instruction codes of the area 32 record the data received from the physical ballot box into the database 19.

An area 33 includes information codes to transmit data from the physical ballot to the vote server 12.

The database 18 is first defined in a table. For example, each row of the table corresponds to a voter, each column of the table corresponds to a piece of information about that voter. Thus, the database 18 includes a row 18a corresponding to an identifier of the user if his vote code is identity or nominative. This identifier includes a field where a surname of the voter is filled in, a second field where a first name of the voter is filled in, a third field where an address of the voter is filled in and a fourth field where the place of granting of the vote code is filled in.

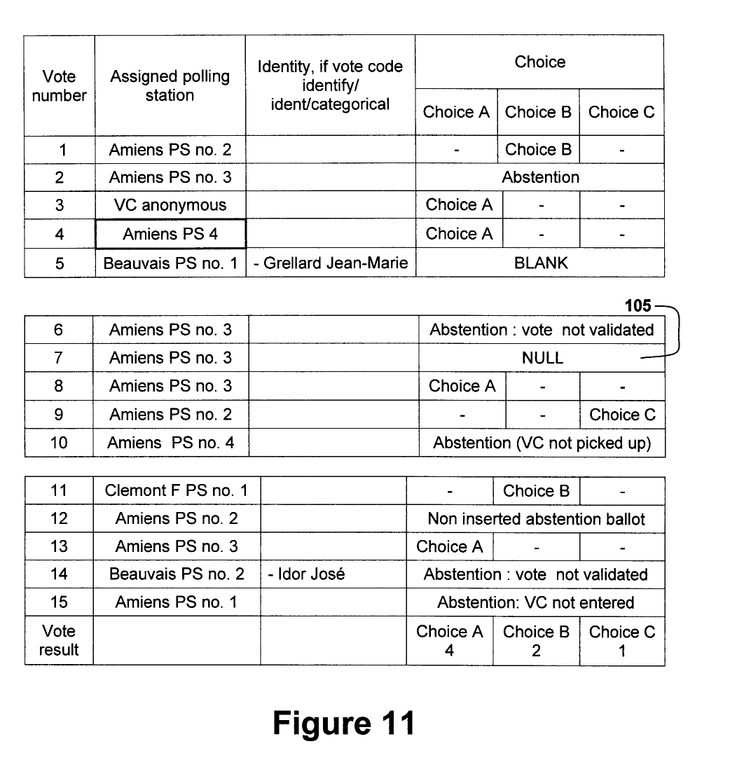

The database 18 includes a column 18b corresponding to the vote code file generated according to the assigned categories of the voters. The database 18 includes a column 18c corresponding to the different possible types of vote code. The vote codes are given to the voters anonymously.
Only when the vote code type is nominative, identity or a combination (e.g. nominative and categorical . . . ), the identity of the voter 18a of the column is filled in.
When the code type of vote is categorical, categories can be assigned to the voter. As an example, the base 18 contains columns 18d, 18e, 18f, 18g and/or 18h filled in because they are all categories that can be assigned to the voters.
When the vote code type is identity the fields in the row 18a are filled in and these data are not intelligible because the identity of the voter is visible. The list of public voting result (FIG. 11 vote row No. 5), thereby enables any third party to know the electoral choice of this voter.

The types of vote code, cited above, can be combined. All the vote codes, except these: identity, identity/categorical, nominative and nominative/categorical are rendered unintelligible in the column 18b, for example by encryption. This encryption enables avoidance of any computer connection between the identity of the voter and the vote code file or the vote number file of this voter.

Columns 18d to 18h corresponding to information on the categories about the voters, among others:
column 18d indicates the sociological function of the voter, for example, technician, employee, unemployed, worker etc.
column 18e indicates the sociological position of the voter, for example executive, non-executive, supervisor,
column 18f indicates the electoral board(s) to which the voter belongs,
column 18g indicates the vote number n allowed to the voter, and
column 18h indicates the assigned polling station of the voter.

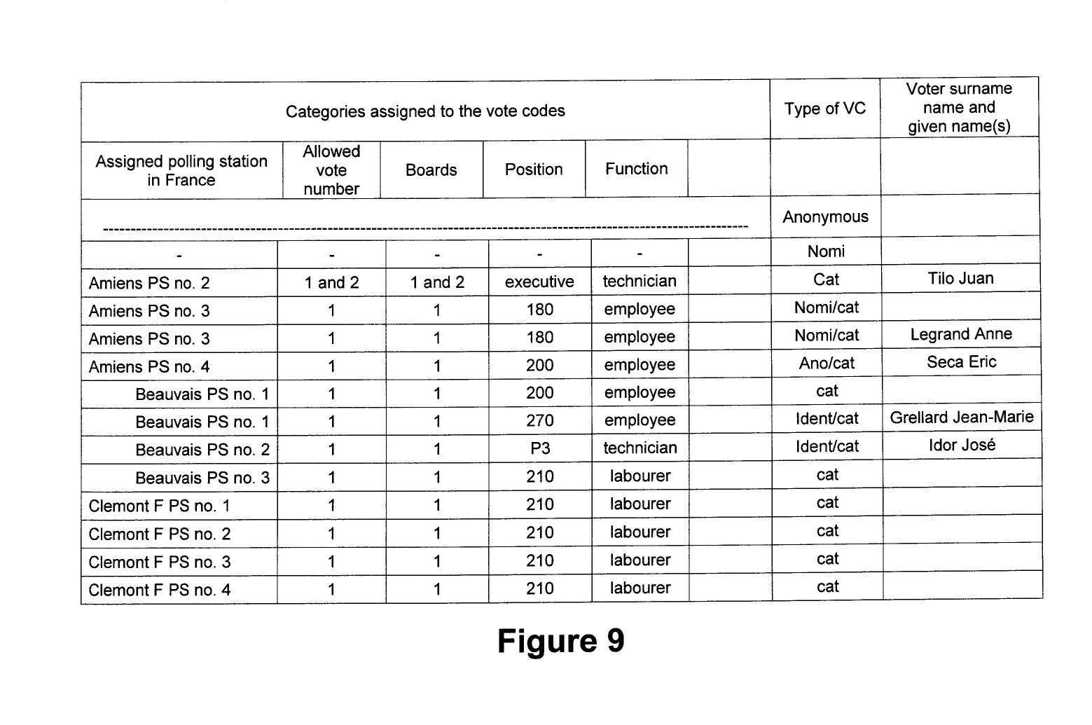

The data base 18 contains data contained in an electoral list (FIG. 9). An example of an electoral list is shown in FIG. 9. The electoral list is public. It includes the identity of voters according to the type of vote code associated with the voters and the categories associated with each voter. The data contained in the electoral list 103 are recorded in the data base 18 before the start of the electoral election. This recording can be effected by a network administrator or any third party authorized to do so. This data base 18 is updated with each new generated vote code.

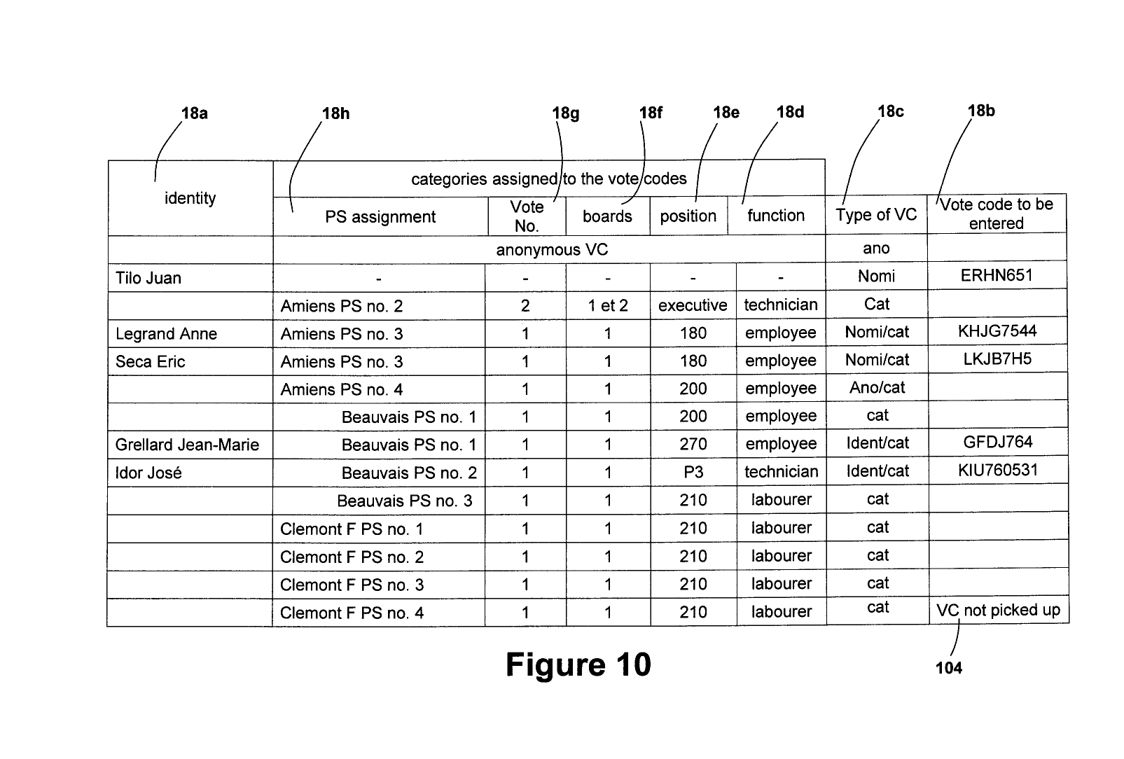

FIG. 10 (vote code generation list) shows a schematic representation of a table 104 extracted from the data base 18. FIG. 10 shows that the identity column 18a is not filled in when the vote code type of vote is:
anonymous, or
anonymous/categorical, or
categorical.

The data base 19 (FIG. 1) is, for example, structured as a table where each row of the table corresponds to a provisional vote number, and each column of the table corresponds to a piece of information about this provisional vote number. Thus, the data base 19 includes a row 19a corresponding to a provisional vote number assigned to a voter. The data base 19 includes a column corresponding to a vote ballot file of this voter. The data base 19 includes a column 19 corresponding to a provisional validation code file associated with the vote ballot file of column 19b. The data base 19 includes a column 19d corresponding to data about the possible physical vote ballot. The data base 19 includes a column 19e corresponding to the identity of the voter, which is filled in only if the vote code is identity or identity/categorical.

The data base 20 is for example structured in the form of a table where each row indicates a vote choice.

The server 12

The vote server 12 (FIG. 1) includes a microprocessor 41, a program memory 42, a data base 43 of votes and a data base 44 of the vote result for the polling station concerned. The elements 41 to 44 are connected by a bus 45.

The program memory 41 is divided into multiple areas, each area corresponding to a function or a mode of operation of the program of the vote server 12.

An area 46 includes instruction codes to receive and process the data received from terminals 11 (base 19) of the polling station and record the data in the database 43 of definitive vote ballot files.

An area 47 includes, in case of implementation, instruction codes to compare, for each validation code, the data contained data in the vote ballot file to the data contained in the corresponding physical vote ballot. An area 48 includes instruction codes to send an error message to the proper authorities via the network 13, when the comparison from the area 47 returns 0, that is to say for a same validation code the data contained in the vote ballot file are not identical to those contained in the physical vote ballot.

An area 49 includes instruction codes to increment result counters (not shown), when the comparison from the area 47 returns one, that is to say for a same validation code the data contained in the vote ballot file are identical to those contained in the physical vote ballot. These counters are incremented according to the selection of the choice contained in these vote ballots. A counter is associated with each choice of the database 20.

An area 50 includes instruction codes to effect a read of the counters to perform a vote counting. The vote result obtained from the vote counting is recorded in the database 44. The database 44 is structured, for example, in the form of a table where each row indicates an electoral choice resulting from the list of choices of the database 20 from the voting terminal 11. A column indicating a vote result on the choice of this row is associated with each row of the database 44.

When the vote is closed, for the non-confirmed parameters of this voting station, the instruction codes of the area 51 transmit to the server 14 the abstention ballot files associated with their definitive vote numbers and with the identity of the voter if the type of vote code is identity or identity/categorical.

An area 51 includes instruction codes to transmit, to the centralization server 14 via the network 13, the definitive vote ballot files associated with their definitive validation code file and their definitive vote number and the identity of the voter if the vote code type is identity or identity/categorical.

An area 52 includes instruction codes to display on a screen connected to the server 12 the vote result from this polling station. This vote result can also be printed via a printer connected to the server 12.

The server 14

This server centralizes, via the network 13, the set of vote incremented for the set of the:
vote servers 12 of the polling stations,
votes cast outside of the polling stations.

When the vote is closed, the centralization server 14 receives the set of abstention ballot files of registered voters, from the servers 12 of the polling stations. The abstention ballot files recorded by the server 14 are of five different types:

1) abstention ballot file associated with a vote for which the voter has entered his vote code but of which the voter has not confirmed the choice of this vote (ex: FIG. 11 row No. 6 and 14),

2) abstention ballot file associated with the vote for which the voter did not input or enter his vote code that he obtained (ex: FIG. 11 row No. 15).

3) abstention ballot file associated with the vote for which the possible vote ballot material coming from the polling station was not inserted in the ballot box (ex: FIG. 11 row No. 12),

4) abstention ballot file associated with the vote for which the voter did not receive a vote code (ex: FIG. 11 row 10).

5) abstention vote ballot file for which the voter deliberately cast this choice to abstain on the electronic voting device (ex: FIG. 11 No. 2).

When the vote is closed, for the votes cast outside of the stations, the parameterized vote ballots files with vote code files, but that were not centralized by the server 14, are declared abstentionist according to the types 1 to 4 above. A vote number file is assigned respectively to these abstentions.

The vote centralization server 14 includes a microprocessor 55, a program memory 54, a data base 56 (for the confirmed votes) and a data base 57 (for the non-confirmed votes). The elements 54 to 57 are connected by a bus 58.

The program memory 54 is divided into multiple areas, each area corresponding to a function or mode of operation of the vote centralization server program 14.

An area 59 includes instruction codes to process the data received from the network 13.

An area 60 includes instruction codes to manage the vote numbers coming from the:
vote ballot file associated with their validation code files received from the centralization servers 12, when the corresponding vote was incremented,
abstention ballot files received from the: centralization servers 12 and vote terminals situated outside of polling stations, when the corresponding votes were incremented
abstention ballot files possibly created by the centralization server 14 for voters unregistered in the polling station, and when the vote is closed.

These received vote numbers are:
always definitive for the votes in polling stations, when the vote(s) was/were confirmed by the voter,
always provisional for the votes carried out outside of the voting stations. But these numbers become definitive, by an action of the server 14, when the electoral period has expired. This particularity enables to the voters (exception for votes from the voting station) to be able to modify their vote(s) during the electoral period. Indeed, if the vote, for example, is not sincere, that is to say if the vote is cast under duress, then the voter can revote. It is always the last vote that prevails. The vote number is preferably assigned chronologically by: the voting terminals 70 or 11 or the server 14 for the creation of abstention ballot files. In a variation, this definitive vote number is assigned by alphabetical order or randomly. In the invention, each vote number is unique to each vote ballot or abstention ballot file.

An area 61 includes instruction codes to record, when the vote is closed, in the database 57 or 56, the definitive vote number associated with the vote or abstention ballot file and possibly the identity of the voter when the type of vote code of the latter is identity or identity/categorical. These recordings effected in the database 57 and 56 enable creation of a vote result list. FIG. 11 shows a schematic representation of a vote result list extracted from the databases 57 and 56. The vote result list can be viewed in public places such as the voting stations, the town hall, the embassies, via the network 13, the police, the prefecture etc. . . .

In the invention, the voter can vote in a polling station other than his assigned polling station or possibly via his personal computer.

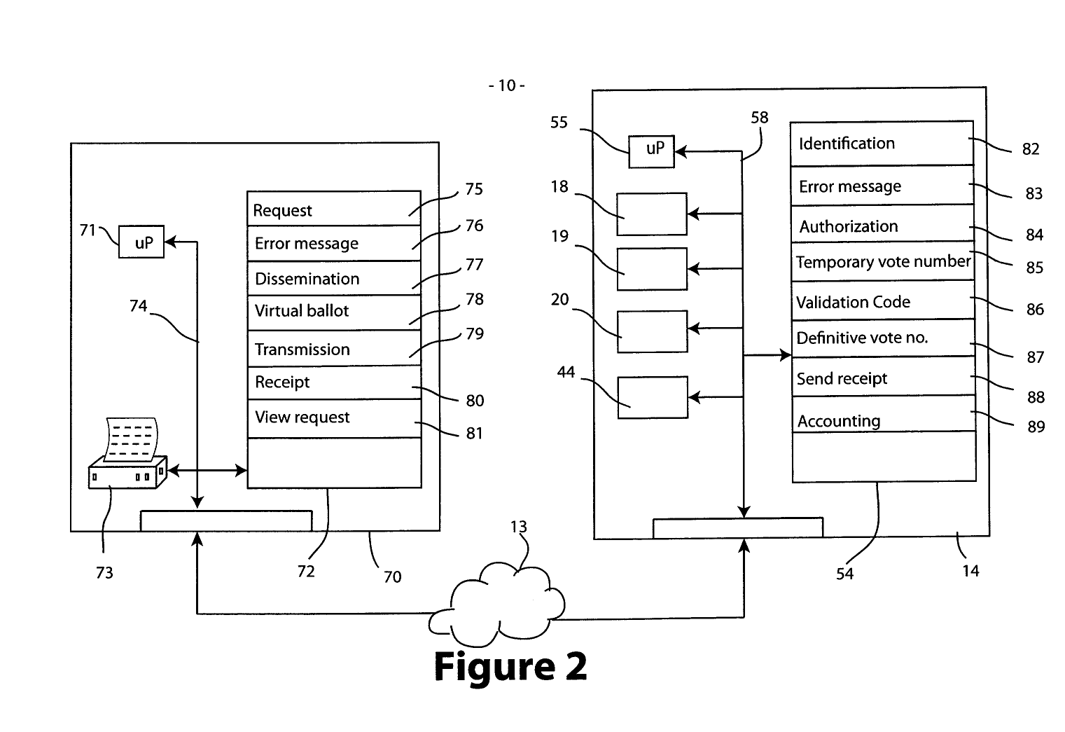

FIG. 2

Shows a system 10 for electronic voting via a vote terminal 70 situated outside a polling station.

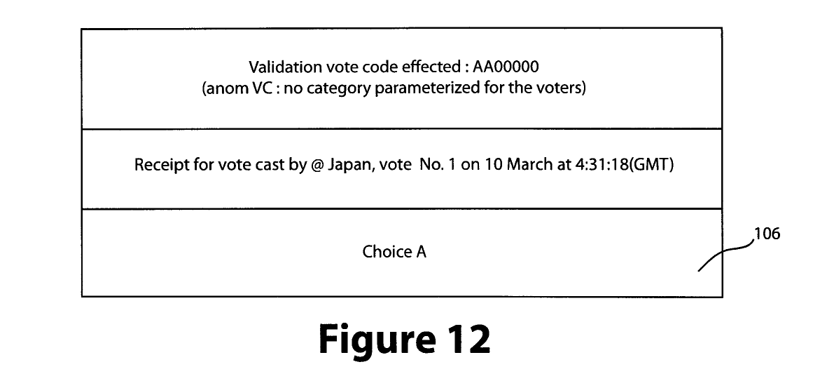

The vote terminal 70 can be a personal computer, a mobile telephone, a personal assistant or any other equivalent device. The vote terminal 70 is connected to the vote centralization server 14 via the communication network 13. The vote terminal 70 includes a microprocessor 71, a program memory 72 and a printer 73. The element 71 to 73 are connected by a bus 74. The vote terminal 70 can also include a touch screen and/or a keyboard. The program memory is divided into multiple areas, each area corresponding to a function or a mode of operation of the program of the vote terminal 70. An area 75 includes instruction codes to send a vote request to the centralization server 14 via the network 13 as a result of the validation from the user. This vote request includes the vote code inputted or entered by the voter. An area 76 includes instruction codes to receive an error message from the network 13 when the vote code is incorrect. An area 77 includes instruction codes to receive from the network 13 a dissemination of choices from the database 20. An area 78 includes instruction codes to create a vote ballot file including a piece of information about the vote choice selected and confirmed by the voter. An area 79 includes instruction codes to transmit the vote ballot file to the centralization server 14 via the network 13. An area 80 includes instruction codes to start the printing of the receipt for the cast vote(s) via the printer 73. FIG. 12 shows an example of a cast vote receipt from a terminal 70. This cast vote receipt includes in particular the validation code and advantageously the choice of vote ballot in order to enable the voter to authenticate his vote, when this possibility will be offered after the announcement of the result of the electoral process.

The vote server 14 also includes databases 18, 19, 20 and 44. The program memory 54 also includes an area 82 including instruction codes to compare the vote code of the received vote request to the vote codes of the vote code files of the database 18.

An area 83 includes instruction codes to send an error message on the terminal screen 70, when the comparison returns zero, that is to say when the entered vote code did not correspond to any of those of the database 18. The error message can be “vote code incorrect”.

An area 84 includes instruction codes to execute the same operations as those described for area 25 of program memory 16 of the vote terminal 11 of FIG. 1.

An area 85 includes instruction codes to assign a provisional vote number, when voting is authorized.

An area 86 includes instruction codes to generate a validation code file associated with the provisional vote ballot file and to increment a vote counter when the selected choice is validated and confirmed. The area 86 also includes instruction codes enabling recording of the validation code file associated with the vote ballot file in the data base 19.

An area 87 includes instruction codes to make definitive the provisional vote numbers of the vote ballot files when the vote is closed.

An area 88 includes instruction codes to transmit a vote receipt to the terminal

An area 89 includes instruction codes to increment the counters (not shown), according to the selection of the choice contained in the vote ballot files. A counter is associated with each choice. The instruction codes of the area 89 also effect a reading of the counters in order to perform a vote counting. The vote result obtained from the vote counting is recorded in the data base 44.

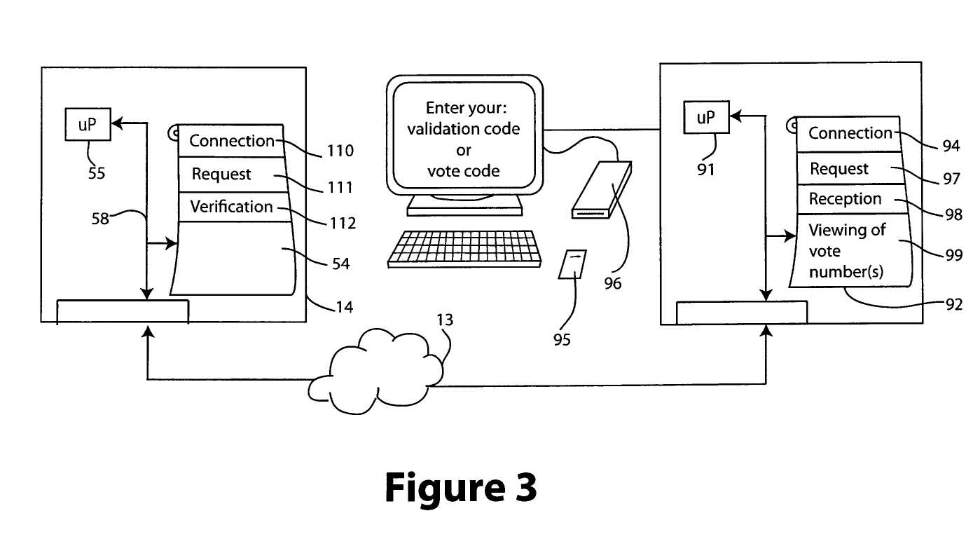

FIG. 3

Shows the means for the voter to view his definitive vote number(s) associated with his vote(s). A vote number is obtained by the voter via a computer (No. 90) having a secure connection with the server 14. The computer 90 is preferably installed in secure locations such in particular a police station, a police prefecture station, a town hall, an embassy, a consulate, etc. . . .

The computer 90 includes in particularly a microprocessor 91 and a program memory 92 connected by a bus 93. The program memory 92 is divided into multiple areas, each area corresponding to a function or a mode of operation of the program of the program of the computer 90.

An area 94 includes instruction codes to establish a secure connection with the server 14. To do this, an advanced voter authentication system is installed based, for example, on an IC card 95 using advanced cryptographic techniques. The computer 90 includes means 96 for authentication and verification of the card 95 before authorizing the execution of instruction codes of the connection area 94.

An area 97 includes instruction codes to transmit, in secured mode over the network 13, a request for a definitive vote number, as a result of a validation of a vote code or validation code entry form. This request for vote number includes the vote code or validation code that is attached to it. An area 98 includes instruction codes to receive in secured mode a response from the server 14 via the network 13. An area 99 includes instruction codes to process and view the received response. This response is an error message when the vote or validation code does not exist in the databases of the server 14. This response is the definitive vote number extracted from the databases of this centralization server 14, if it is associated with a vote ballot or abstention ballot file.

The program memory 54 of the centralization server 14 (FIG. 2) also includes an area 110 (FIG. 3) including instruction codes to establish a secured connection with the computer 90 when an authorization has been validated. An area 111 includes instruction codes to receive and process a vote number request via the secured connection. An area 112 includes instruction codes to verify if the data of the validation code or vote code file contained in the request have a correspondence with respect to the data of the files: vote codes and/or validation code in one of the databases 57 or 56 of the centralization server 14 (FIG. 1). If the verification returns zero, that is to say no correspondence, then an error message is sent to the computer 90. If the verification returns one, then the definitive vote number assigned to this data is extracted and sent to the computer 90.

The representation of databases and program memory of vote system 10 is only an illustration of implementation of components and recording of data. In practice these databases and program memories are unified or distributed according to constraints of size, and desired security and/or processing speed.

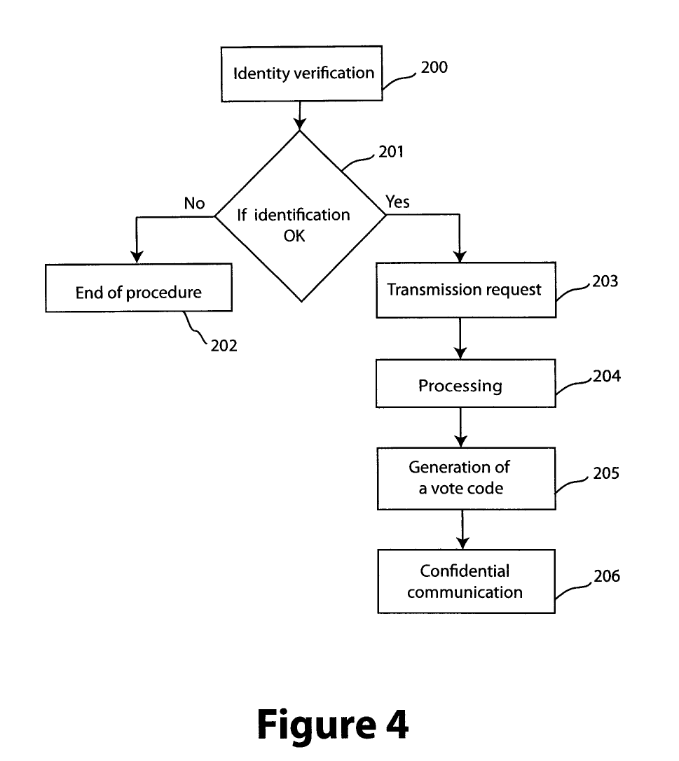

FIG. 4

Shows an illustration of steps corresponding to an example of assignment of a vote code file to a voter. The vote code file can be assigned in the voting stations or before the opening of the voting stations in the secured locations. The vote code of the vote code file enables the voters to vote according to their categories. The vote code file is individual and unique to each voter. It is delivered confidentially to the voter by an agent that sends, at a step 203, a request to generate a vote code file to the network

FIG. 4 shows a first preliminary step 200 wherein the identity of voter is verified. This verification is made by proper authorities in polling stations or in the secured locations.

At a step 201, if the voter does not have a valid voter card or is not registered in the electoral rolls then the agent does not issue any vote code and the procedure is terminated, a step 202.

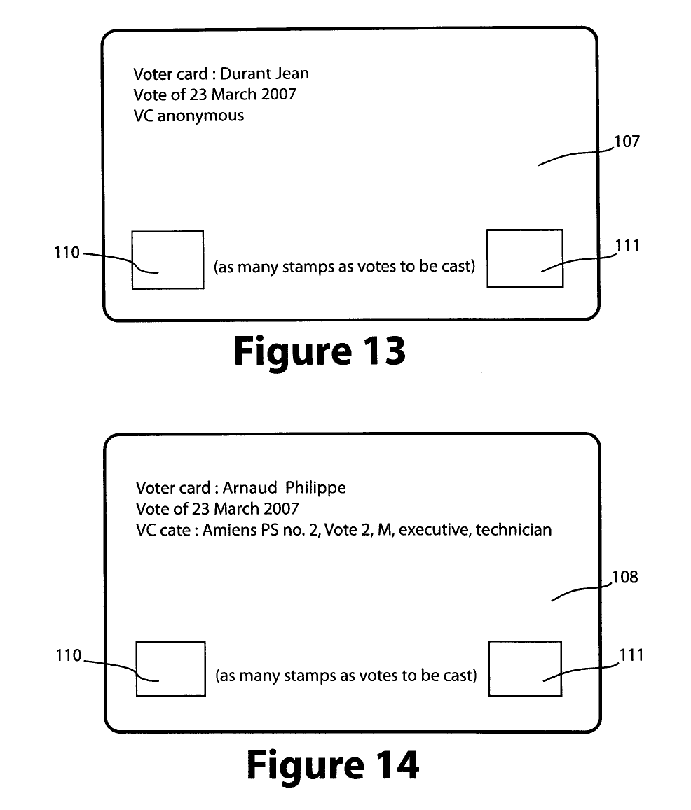

FIGS. 13 and 14

Shows two examples of voter cards 107 and 108. FIG. 13 shows an example of a voter card where the type of vote code is anonymous. FIG. 14 shows an example of a voter card 108 where the type of vote code is categorical. The cards 107 and 108 include an area 110 adapted to receive a vote code imprint. A vote code imprint is a distinctive mark affixed on this area and designed to indicate that a vote code is already picked up by the voter. This vote code imprint can be a stamp affixed by the agent possibly accompanied by a physical signing. The cards 107 and 108 can also include an area 111 adapted to receive a vote imprint. A vote imprint is a distinctive mark 111 affixed on this area 111, preferably in a polling station, and designed to indicate that the voter has voted. The vote code imprint can be a stamp affixed by an agent, possibly accompanied by a physical signing. In a variation, this vote code imprint can also be accompanied by a mark affixed on the skin of the voter.

At step 201 FIG. 4, if the area 111 of the voter card includes:
a vote code imprint, then no other vote code is reissued if the type of vote code is anonymous, categorical or anonymous/categorical. And the vote code assignment procedure is terminated at step 202.
a vote code imprint, another vote code can be generated when the type of vote code is nominative, nominative/categorical, identity and identity/categorical. In this case, it will be verified whether the code already issued already voted, in which case if it is an identity code (or its components), all the votes will be annulled, if it is a nominative code, a code will not be issued because the votes coming from nominative codes cannot be annulled. If a second code is delivered, only the votes cast by the second generated code will be counted.
no vote code imprint, a request for generation of vote code file can be effected irrespective of the type of vote code.

The generation request is sent by the agent pressing on a button connected to the generation computer. This generation computer can be the centralization server 14. The pressing of this button causes the generation of a vote code and the recording of this vote code file in the database 18 for this type of vote code.

When the vote code type is categorical, nominative, nominative /categorical, identity or identity/categorical, the generation request is sent to the generator computer as a result of validation of a vote code file request form. This form information includes fields to indicate, such as in particular, the type of vote code and the categories of voter indicated on his voter card. The identity of the voter is filled in only if the type of vote code is identity, identity/categorical, nominative or nominative/categorical.

In a step 204, the centralization server 14 processes this received request and creates at a step 205 a vote code file then records it in the database 18. If the identity of the voter is filled in the server 14 verifies if a vote code file is already assigned to this identity. If this verification returns one, that is to say a vote code file exists for this identity, then an error message is transmitted by the server 14 to the agent terminal. This error message can be a request for reassignment of the vote code.

If this verification returns zero, that is to say no vote code file exists for this identity, then the server 14 creates at step 205 a vote code file and records it in the database 18.

The centralization server 14 transmits this vote code file to the agent terminal via the network 13. The vote code contained in this vote code file is then communicated confidentially or even readable to the requester, at a step 206. In the description, the term readable signifies that the voter has a means to read it. That is to say the vote code file is furnished to the voter on a substrate on which he can directly read it, such as a printer or a screen. The vote code file can also be provided on an IC card. In this case, the vote terminal includes means to read it. The vote code file can also be provided with a decryption key and a decryption program enabling the voter to be able to decode it on his personal computer.

This vote code file is preferentially issued only once. The vote code file includes a field indicating the place of assignment. In a preferred implementation mode, if the vote code file is communicated in a polling station then no other vote code file is reissued. Indeed, voting is expected in the polling station as soon as the communication of the vote code.

If the first vote code file is communicated in a secured location then a second vote code file can be reissued in a polling station only if:
the vote code was not entered (for vote codes type: nominative, categorical and nominative/categorical) on the electronic voting device. A verification is effected to that effect by the agent.
the vote code type is identity or identity/categorical. In this case, a new generation is effected after the annulation of the vote(s) confirmed for the vote ballot file(s).

In order to indicate that a vote code was already communicated to a voter, a vote code imprint is affixed on the area 110 of the voter cards 107, 108 of the aforementioned voter.

FIG. 5

Shows an illustration of steps corresponding to an implementation of the method according to the invention.
At step 220, a vote code file is confidentially generated for a voter. This vote code is a right to vote for the vote(s) assigned to this vote code. This generation can be effected according to that described in FIG. 4.
At step 221, the voter inputs or enters his vote code contained in the vote code file and possibly confirms it by pressing a validation button of the keyboard of the vote terminal or an area of the screen of the aforementioned terminal when the latter is tactile.
At step 222, the vote terminal verifies whether the vote code file has a correspondence in the database. If a correspondence exists, then the vote number n associated with this vote code file is compared to the number from the vote counter allowed for this vote code. If the vote number n is equal to the number from the vote counter then an error message is displayed, at a step 223, on the screen on the vote terminal. This error message can be of the type “already voted”, “incorrect code”.
At step 224, if the vote code allows voting, he is presented all the allowed votes.
At step 225, he is presented all possible options for electoral votes selected at step 224. This authorization message includes, intra alia, a list of choices extracted from the data base 19 FIG. 1. The voter expresses his electoral choice by selecting at least one choice from the list presented.
At step 226, the provisional generations are effected:
a vote number considering the selection cast at steps 224 and 225. This temporary vote number can be generated chronologically,
a validation code. In a variation, it is possible that the voter totally or partially composes, on the vote terminal, the characters of his validation code.

Depending on whether the vote is cast in a polling station (250) with voting booths, official staff and possibly tangible ballot boxes or a private place (example of a vote by Internet from his home, 240), the following steps are to be taken into consideration:

Step 250, the voting is cast in a polling station (FIG. 1):
At step 251, a 1st validation of the electoral choice, coming from the choice of step 225, is requested:
If the voter does not validate, step 251 bis is effected. The electronic voting system erases the generated validation code and the vote number file. A return to step 224 for a possible modification of electoral choices.
If the voter validates, step 252 is next.
At step 252, a provisional vote ballot file is created, the vote ballot file, associated with the validation code file and with the vote number, is inserted into a virtual ballot box by incrementing counters (FIG. 1 no. 20) according to the choice. In a variation, it is possible that the voter totally or partially composes, on the voting terminal, the characters of his validation code.
At step 253, advantageously, a printing of a tangible vote ballot understandable to the voter is effected. On this vote ballot is in particular indicated the validation code and the electoral choice.
At step 254, if the electoral process provided the printing of a vote ballot on a tangible medium, a second validation, of correspondence between the printing of a tangible vote ballot and the indication of the electoral choice visible from the screen of the electronic vote terminal:
If the voter validates the correspondence, step 255 is next.
If the voter does not validate the correspondence (lack of compliance or change of choice), the electronic voting system returns to step 224 for a possible modification of the electoral choice of the vote initially selected. In this case the electronic voting system erases (254 bis) the generated validation code and vote number file.
At step 255, if other vote(s) possible, the voter is asked if he wishes to have access to this/these other vote(s)? If the answer is yes, step 224 is next. If the answer is negative, step 256 is next.
At step 256, the electronic voting system prints the receipt for all the votes cast (all those parameterized by the vote code and presented at step 224) with these indications:
the vote(s) having been validated at step 251 and/or 254 is/are indicated with a unique and respective correspondence with a validation code of their own (each electoral choice has its unique validation code),
the vote(s) not having been validated at step 251 and/or 254 is/are indicated abstentionist without correspondence with a validation code (the voter will possibly be able to vote on these votes, but before the close of the electoral process).
At step 257, the voter is asked to confirm the conformity of indications, cited on the receipt for the vote(s) cast, with the electoral choice(s) cast.
If the voter does not confirm, the electronic voting system erases (step 257 bis) the generated validation codes(s) and the vote number files(s). A return to step 224 for a possible modification of electoral choice is effected.
If the voter confirms, step 258 is next.
At step 258, the electronic voting system created one or multiple provisional abstentionist vote file(s) for the vote(s) not having received a provisional vote number file, and thus which did not receive the validation(s) provided in the electoral procedure.
At step 259, the electronic voting system definitely assigns: the validation code(s) and the vote number files(s), to the respective electoral choice(s) to which it/they relate(s). If voting is not closed and the procedure allows it, the voter can re-enter his vote code to select a non-confirmed choice.

Depending on the option chosen, the vote ballot files are transmitted through the network 13 to the server 14 or, in 260 and following steps, the vote ballot files can be stored on a physical medium, a comparison of which can be available.
At step 260, if the voting process provided a printed vote ballot, the ballot box receives the vote ballots at the exit from the voting booth.
At step 261, the ballot box can scan the information contained on the physical vote ballot(s), at the time of its insertion into the ballot box.
At step 262, when the vote requires affixing its mark, the voter presents his vote receipt to an agent of the polling station to affix a vote mark and can/must sign.
At step 263 advantageously, for each validation code file, the data from physical vote ballots recorded by the ballot box (step 261) are compared to the data contained in the vote ballot files (step 259). An anomaly is detected when, for a same validation code file, the choice of vote ballots are different. The physical vote ballots and the possible vote receipts provided by the voters act as proof in litigation. The physical vote ballots are kept for a period determined by the election laws.

With or without comparison, all the vote ballot files are transmitted over the network 13 to the server 14 for acquisition of the result of the electoral process.

Step 240, the vote is cast outside a polling station (FIG. 2):
At step 241, a 1st validation of the electoral choice coming from step 225 is requested:
If the voter does not validate, step 241 bis effected. The electronic voting system erases the generated validation code and the vote number file. A return to step 224 for a possible modification of electoral choice is effected.
if the voter validates, step 242 is next.
At step 242, a provisional vote ballot file is created and inserted into a virtual vote ballot box by incrementing counters according to the choice. This vote ballot file includes the selected choice with two computer correspondences on: 1) validation code file and 2) of the vote numbers, these two references come from step no. 226. In a variation, it is possible that the voter totally or partially composes the characters of his validation code on the vote terminal.
At step 243, if other vote(s) possible, the voter is asked if he wishes to have access to this/these other vote(s)? If the answer is affirmative, step 224 is next. If the answer is negative, step 244 is next.
At step 244, the electronic voting system prints the receipt for all the votes cast (all those parameterized by the vote code and presented at step 224) with these indications:
the vote(s) having been validated at step 241 is/are indicated with a unique and respective correspondence with a validation code of their own (each electoral choice has its unique validation code),
the vote(s) not having been validated at step 241 is/are indicated abstentionist without correspondence with a validation code (the voter will possibly be able to vote on these votes, but before the close of the electoral process).
At step 245, the voter is asked to confirm the conformity of indications, cited on the receipt for the vote(s) cast, with the electoral choice(s) cast:
if the voter does not confirm (step 245 bis), the electronic voting system erases the generated validation codes(s) and the vote number files(s). A return to step 224 for a possible modification of electoral choice is effected.
If the voter confirms, step 246 is next,
At step 246, for an inputted or entered vote code, the electronic voting system created one or multiple provisional abstentionist vote file(s) for the non confirmed votes, thus not having received a provisional vote number file, and thus which did not receive the validation(s) provided in the electoral procedure.
At step 247, the electronic voting system provisionally assigns: the validation code(s) and the vote numbers files(s), to the respective electoral choice(s) to which it/they relate(s). The vote ballot files are transmitted through the network 13 to the server 14.

If voting is not closed, the voter can always re-enter his vote code in order to revote and modify a confirmed choice. It is only at the close of the electoral process that the vote numbers and validation code will be declared definitive by the server 14.

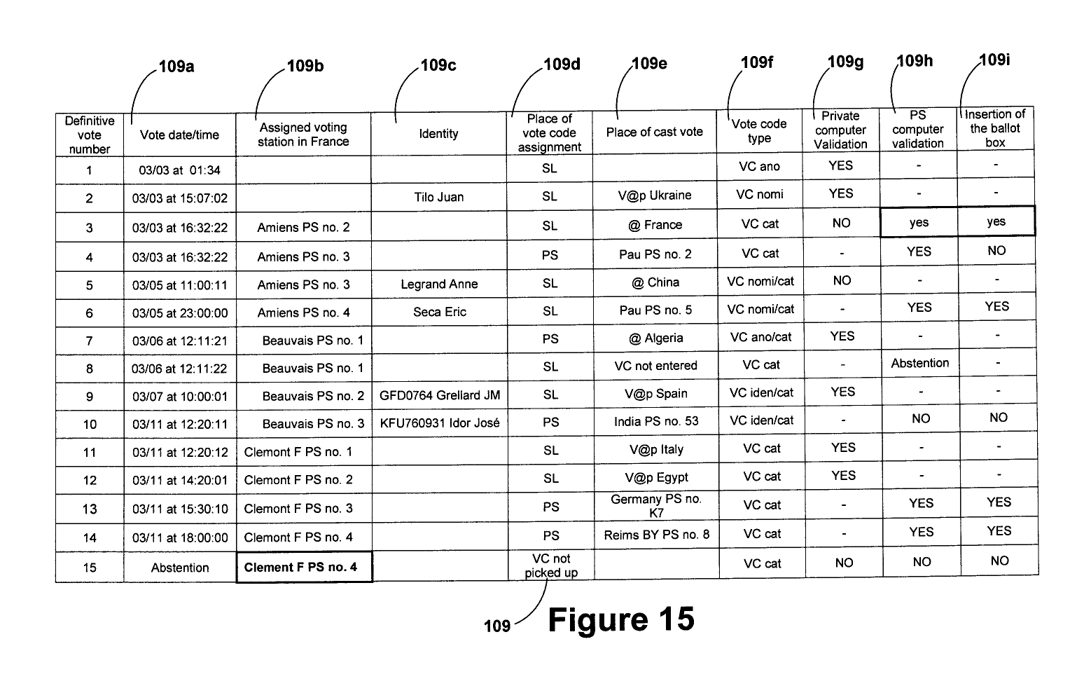

FIG. 15 No. 109

Shows a signature list example. Indeed, in a preferred implementation mode, the centralization server centralization 14 (FIG. 1) can also provide a signature list 109. This signature list 109 can be publicly available depending on the published information. It can be reviewed in public places such as the town hall, the police station, the embassies, the prefecture, etc. . . . The signature list 109 can also be viewed from a personal computer via the Internet network 13 (FIG. 1). In this case, the personal computer transmits over the network 13 (FIG. 1) a request to view the signature list 109.

This signature lists includes:
a column 109a chronologically indicating the hour and date of assignment of the temporary or definitive vote number.
a column 109b indicating the assigned station associated with the vote number,
a column 109c indicating the identity of the voter when the vote code type is nominative, nominative/categorical, identity or identity/categorical,
a column 109d indicating the last place of assignment of the vote code used for voted,
a column 109e indicating the place of the cast vote,
a column 109f indicating the type of vote code,
a column 109g indicating about a virtual signing corresponding to a computer validation, when the vote is cast via a personal computer,
a column 109h indicating about a virtual signing corresponding to a computer validation, when the vote is cast via a voting machine from a polling station,
a column 109i indicating about a physical signing corresponding in particular to a signature of the voter on a physical signature list in a polling station, to a stamp on the area 111 of the voter card or a mark on the skin of the voter.

FIG. 11

At the close of the electoral process, all the non-confirmed votes are declared abstentionist. A definitive vote number is assigned to these abstentionist votes. These abstentionist vote numbers are associated respectively with the vote codes.
The results of votes cast in polling stations and outside polling stations are added together in order to produce the final election results of the electoral process. FIG. 11 shows a vote result. This result can also be viewed from a personal computer via the Internet network 13. In this case, an area 81 (FIG. 2) includes instruction codes for transmitting on the network 13 a request to view the vote list 105. This view request can be a URL, for Universal Resource Locator in English, or Universal Resource Locator.

Verifications allowed to voters and to third parties:

The vote result list 105 (FIG. 11) and the signature list 109 (FIG. 15) enable any third party to consult and verify the voting rights assigned to the voter list. This dissemination of lists 105 and 109 to the public enables reinforcement of the confidence of voters with respect to votes cast via electronic voting systems.

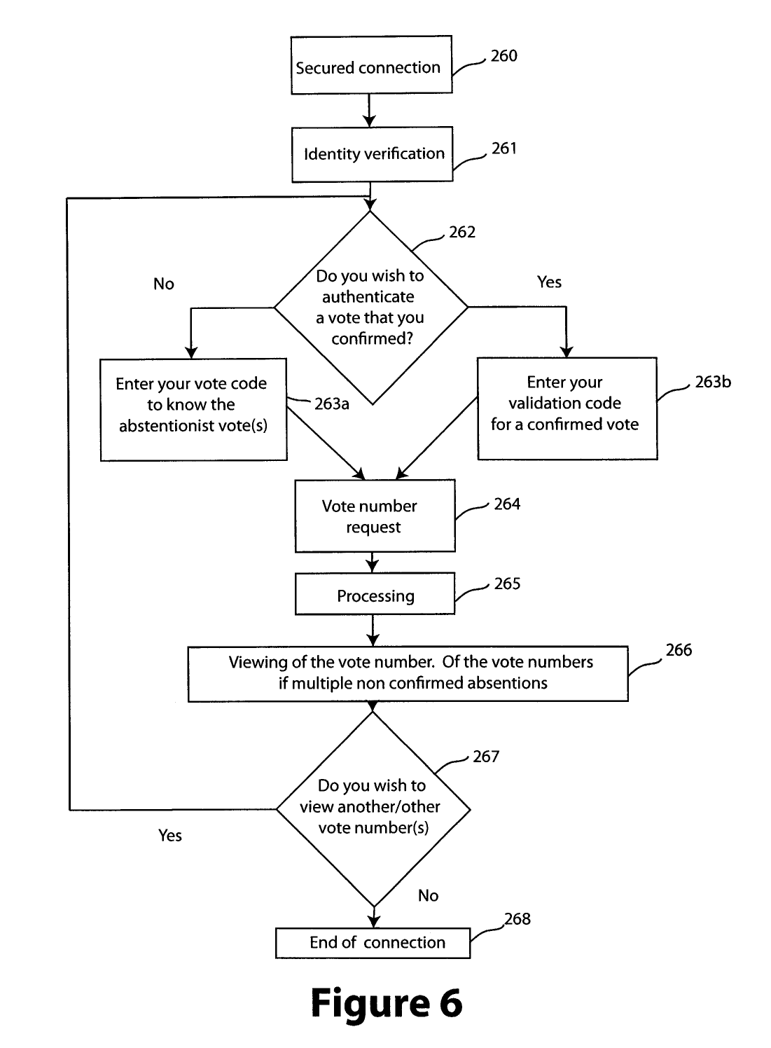

FIG. 6

Shows an illustration of steps corresponding to an example of acquisition of a definitive vote number of a voter. This step is only possible at the end of the electoral process. FIG. 6 shows a first preliminary step 260 wherein a secured connection is established between a computer (FIG. 3 No. 90) and the centralization server (FIG. 3 No. 14).

After having verified (step 260) and authenticated the identity of a voter as authorized applicant having one or multiple definitive vote number(s)), the computer (FIG. 3 No. 90) is made available to the applicant, in a step 262. At step 262, it is asked if the voter wishes, or not, to authenticate a vote that he confirmed. In the two cases the voter will be returned to a form including fields to be filled in such as the validation code or the vote code:
at step 263b, via the entry of the validation code by the voter, the computer (FIG. 3 No. 90) sends a request for definitive vote number to the server (FIG. 3 No. 14) via the network (FIG. 3 No. 13) as a result of a validation of a vote number form.
At step 263a, via the entry of the vote code, the computer (FIG. 3 No. 90) sends a request for definitive vote number to the server (FIG. 3, No. 14) via the network (FIG. 3 No. 13) as a result of a validation of a vote number form. In this event, it relates to all possible abstentionist votes attached to this vote code. The server will respond by sending all the vote numbers attached to the abstentionist votes.
At step 265, the server (FIG. 3 No. 14) processes this received request and extracts from its database the definitive vote number associated with this vote or validation code file.
At step 266, the server (FIG. 3 No. 14) transmits to the computer (FIG. 3 No. 90) the vote number extracted in preparation for its display on the screen of this computer. No material information concerning the vote number(s) can be retained by the voter at the end of this consultation. Indeed, it must be impossible that the voters be able to prove their votes to third parties, to avoid vote-buying.

1. Method for electronic voting, designed to provide an incontestable ballot, characterized in that it includes the following steps:
A) an individualized and confidential vote code file is communicated to each voter identified from a group of voters from an electoral list, this vote code file being in the form of a first sequence of characters and being communicated in a readable or non-readable form to each voter, and
B) one or multiple man machine interface(s) are connected to a vote server via a communication network,
C) a voter inputs or enters his vote code file on the man machine interface, and
D) at the time of an authorization, the voter expresses (a vote choice, in particular by selection from a previously defined choice memory, and
E) at the time of an authorization, two provisional files are generated: a vote number file and a validation code file, and
F) at the time of a first validation of the electoral choice (, the provisional files: vote number and validation code are attached to the vote ballot file, the validation code being in the form of a second sequence of characters, and
G) for the votes in polling station, a 2nd validation can be requested in case of vote ballot printing, so that the voter ensures the conformity of the electoral choice between the physical vote ballot and the display at the screen of the electronic voting device, and
H) at the time of an authorization, a vote receipt is printed with the indications of the electoral choice(s), associated respectively with their validation code, and
I) at the time of an authorization, the vote ballot file(s) that :
were not validated, are provisionally or definitively associated with their respective vote number,
were validated one time or two times (if physical vote ballots are provided), are provisionally associated or definitively associated with their respective vote number and validation code, and
J) for the possible comparison in voting station, the vote ballot files coming from the ballot box and those recorded in the electronic voting device are used to produce the definitive vote ballot files, and
K) at the close of the election procedure, the provisional assignments of the vote numbers and validation codes are definitively associated with the vote ballot files in the server, and the definitive vote numbers with or without the definitive validation codes are used to produce the final election result (.

2. The method of claim 1, characterized in that during the creation of the correspondence, a vote number file is associated with a vote ballot file in a vote record of the vote server, the data of the definitive vote number associated with vote number file, and thus with the vote ballot file, being accessible to the public.

3. Method according to claim 1, characterized in that at the end of the election procedure:
an abstention ballot file associated with each vote ballot file non-confirmed by the voter is created, and
a vote number is associated with this abstention ballot file.

4. Method according to claim 1, characterized in that:
the assigned vote number is possibly in a continuous sequence, but is unique by vote ballot or abstention ballot file.

5. Method according to claim 1, characterized in that:
the vote ballot and abstention ballot files, recorded in the storage means of the server, are counted,
this list of electoral result, including the vote numbers associated with their respective vote ballot or abstention ballot file, is provided, this list being publicly accessible.

6. Method according to claim 1, characterized in that
the voter inputs or enters his: validation code, or his vote code on a terminal provided with a means for secured connection to the server to obtain, respectively, his vote number associated: with the vote ballot file, or his abstention ballot file(s).

7. Method according to claim 1, characterized in that
the voter consults the list of public electoral results with his number(s) of his vote in order to authenticate the conformity of the recorded vote(s) with his real vote(s) such as it/they appear on the vote receipt.

8. Method according to claim 1, characterized in that:
a vote receipt, including in particular the assigned validation code file, is printed.

9. Method according to claim 1, characterized in that:
the data of the vote ballot file is printed on a substrate of a physical vote ballot,
the substrate of the physical vote ballot is inserted into a hardware ballot box adapted to read data contained in or on the substrate during the insertion.

10. Method of claim 9, characterized in that a count of the vote ballot files includes, by way of verification, the following steps:
for each validation code file, the choice expressed in the vote ballot file recorded in the storage means of the server is compared to the vote ballot recorded in the physical ballot box,
an anomaly is detected when the two vote ballots are not identical.
